(19) United States
(12) Patent Application Publication
(10) Pub. No.: US 2006/0227288 A1
(43) Pub. Date: Oct. 12, 2006

(54) MULTIFOCAL LENS

(76) Inventor: Joseph W. Seibert, Moon Township, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/279,329

(22) Filed: Apr. 11, 2006

Related U.S. Application Data
(60) Provisional application No. 60/670,080, filed on Apr. 11, 2005.

(51) Int. Cl. G02C 7/06

(52) U.S. Cl. 351/168

(57) ABSTRACT

A multifocal lens includes convex surface and a concave surface and is made of a single piece of polymeric material. The concave surface includes a near vision segment and a distant vision segment, and an area of demarcation between the near vision segment and the distant vision segment is visible.

### CROSS-REFERENCE TO RELATED APPLICATION

This patent application claims priority to, and incorporates by reference in its entirety, U.S. Provisional Patent Application No. 60/670,080, entitled “Bifocal Lens and Method of Making Same” and filed Apr. 11, 2005.

### BACKGROUND

It is known that as a person ages, the person's eyesight often degrades. In particular, the eye's crystalline lens may stiffen. This results in a condition called presbyopia, in which the person encounters difficulty focusing on close objects. The effects of presbyopia may occur gradually, and usually are noticed around the age of forty or forty-five when the person finds that close objects are blurry.

Multifocal lenses, such as bifocal and trifocal lenses, have been developed to help individuals overcome the effects of presbyopia. A traditional bifocal lens is a lined bifocal which is a lens made up of a top half and a bottom half, each with different geometries and dioptric powers. The power of the bottom segment may be such that vision through it permits focusing on reading material and other near objects, while the top half may permit and/or correct vision for viewing distant objects. In a lined bifocal, the two segments create “windows” of clear near vision at or in the bottom of the lens and distant vision at the top of the lens or outside the near vision window. The line of separation between the top and bottom segments may be visible due to the abrupt change in curvature on the surfaces of the two segments.

Lined bifocals have existed for hundreds of years, dating back to the time when Benjamin Franklin created the first lined bifocal in 1745. Since then, bifocals have been made by fusing two segments of glass together, with the line demarking the “seam” or connecting point of the glass segments. Exemplary lenses and methods of making them are shown in U.S. Pat. No. 1,445,227 to Meyrowitz; U.S. Pat. No. 1,509,636 to Bugbee; and U.S. Pat. No. 2,053,551 to Culver, each of which is incorporated herein by reference in its entirety. Other bifocals have been made from molding a plastic or polycarbonate material into a single lens. Exemplary methods of making such lenses are shown in U.S. Pat. No. 5,861,934 to Blum et al. and U.S. Pat. No. 6,786,598 to Buazza, each of which is incorporated herein by reference in its entirety.

Referring to FIGS. 1A and 1B, in the prior art, in both glass lenses and plastic lenses, a lens 10 has a convex surface 11 and a concave surface 12. The concave surface faces the wearer's eye, and a near vision segment 13 is countersunk into the convex surface 12, while the remainder of the convex surface 12 serves as a distant vision segment. Similarly, FIGS. 2A and 2B show a prior art lens 20 having a convex surface 21 and a concave surface 22. The concave surface faces the wearer's eye, and a near vision segment 23 is fused to the convex surface 22. The remainder of the convex surface 12 serves as a distant vision segment.

Recent improvements in bifocal lenses have allowed the creation of lenses where the “seam” or line of demarcation between the segments is not visible to the naked eye. Examples include blended bifocals, which retain a clear distinction between top and bottom segments but blend the line of demarcation. Other lenses, known as progressive addition lenses, provide a gradual transition between the top and bottom segments by providing a sequence of steps between the top and bottom segments.

To date, the materials used in multifocal lenses have been limited to glass and a limited number of polycarbonate and plastic materials. Methods of making lined bifocals from materials having a high refractory index have not yet yielded desirable results. In addition, methods of making lined bifocals from treated materials, such as certain coated or molded materials that darken or lighten based on exposure to ultraviolet rays, have not yet yielded desirable results. In addition, because the prior art multifocals must be made from pre-made segments, the range of customization that is available to a particular lens manufacturer is limited to those combinations of segments that are on hand or which may be separately made onsite.

The description provided herein is directed to solving one or more of the problems described above.

### SUMMARY

In an embodiment, a lens includes a first surface and a second surface and is made of a single piece of material. The second surface is positioned opposite the first surface and includes a near vision segment and a distant vision segment. In some embodiments, the first surface is convex and the distant vision segment of the second surface is concave. A visible area of demarcation exists between the near vision segment and the distant vision segment. The lens material may have a refractory index of about 1.53 or higher, and in some embodiments the material has a refractory index that is between about 1.58 and about 1.74.

In some embodiments, the area of demarcation has a width that is about 3 mm or less. In some embodiments, the near vision segment has a perimeter, and the width of the area of demarcation varies around the perimeter.

In an alternate embodiment, a lens includes a convex first surface and a second surface that is positioned opposite the first surface. The second surface includes a near vision segment and a concave distant vision segment. An area of demarcation is visible between the first near vision segment and the first distant vision segment. The lens is formed of a single piece of material having a refractory index of about 1.53 or higher.

Optionally, the refractory index of the material is between about 1.58 and about 1.74. Also optionally, the area of demarcation has a width that is less than 3 mm, and it may vary about the perimeter of the near vision segment. Optionally, multiple near vision segments having different radii of curvature may be present, and two or more of the near vision segments may partially or fully overlap. Also optionally, multiple distant vision segments having different radii of curvature may be present.

In an alternate embodiment, a method of preparing a unitary multifocal lens includes selecting a lens blank having a first surface that is convex and an opposing second surface. The lens is a single piece of mid-index or high-index material. The method also includes grinding the second surface to form a near vision segment and a distant vision segment in the convex surface such that an area of demarcation between the near vision segment and the distant vision segment is visible.

The grinding may include turning the lens in the presence of a grinding tool so that the distant vision segment has a concave radius of curvature and the near vision segment has a radius of curvature that is different from that of the distant vision segment. The method may include polishing the second surface, and it also may include coating the second surface.

### BRIEF DESCRIPTION OF THE DRAWINGS

FIG. 1A is a side view of a prior art bifocal lens, while FIG. 1B is a front view of the prior art bifocal lens.

FIG. 2A is a side view of an alternate prior art lens, while FIG. 2B is a front view of the alternate prior art lens.

FIG. 3A is a side view of an exemplary multifocal lens described herein, while FIG. 3B is a front view of the exemplary multifocal lens.

FIG. 4A is a side view of a different exemplary multifocal lens described herein, while FIG. 4B is a front view of the same exemplary multifocal lens.

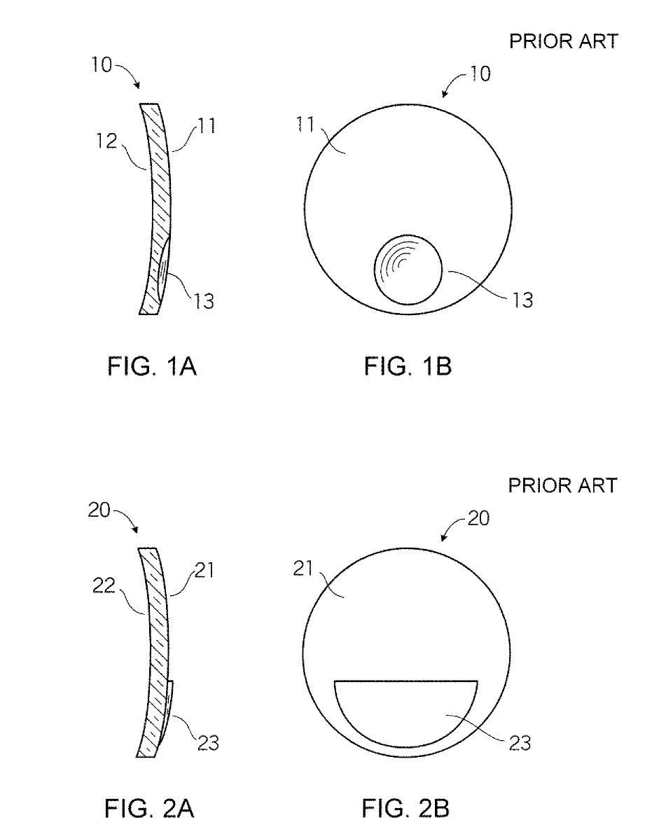

### DETAILED DESCRIPTION

Before the present methods, systems, and materials are described, it is to be understood that this disclosure is not limited to the particular methodologies, systems, and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. In addition, reference to a “multifocal” lens is a reference to a lens having at least two distinct segments, and thus may include a, bifocal, trifocal or multifocal lens and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the invention, the preferred methods, materials, and devices are now described. All publications mentioned herein are incorporated by reference. Nothing herein is to be construed as an admission that the invention is not entitled to antedate such disclosure by virtue of prior invention.

The index of refraction (refractory index) of a lens or lens segment is a numerical expression comparing the speed of light in a transparent medium, like glass, with the speed of light in air. The refractory index of a lens material may indicate how much the material will refract or bend light as the light enters the material from air. The higher the index number of a given lens material, the more the light may refract as it enters the material. If a material has a greater ability to refract light, less of a curve may be required to obtain a specific power, resulting in a thinner lens.

Crown glass (1.52 index) and CR-39 plastic (1.498 index) are often considered to be baselines when comparing lens indices, as such materials are available in a wide variety of lined bifocals. Lens materials with an index of refraction higher than that of CR-39 or Crown glass may be considered to be mid-index or high index materials. Materials with an index between 1.53 and 1.57 may be considered to be mid-index, while materials having indices of about 1.58 or greater may be considered to be high-index. Examples of such materials may be materials with refractory indices of about 1.6, 1.66, 1.67, 1.7, 1.71, 1.74 or higher. Various materials having such refractory indices are known to those skilled in the art. Examples include polycarbonate Transitions® lenses and lenses available from Essilor, Sola, and others.

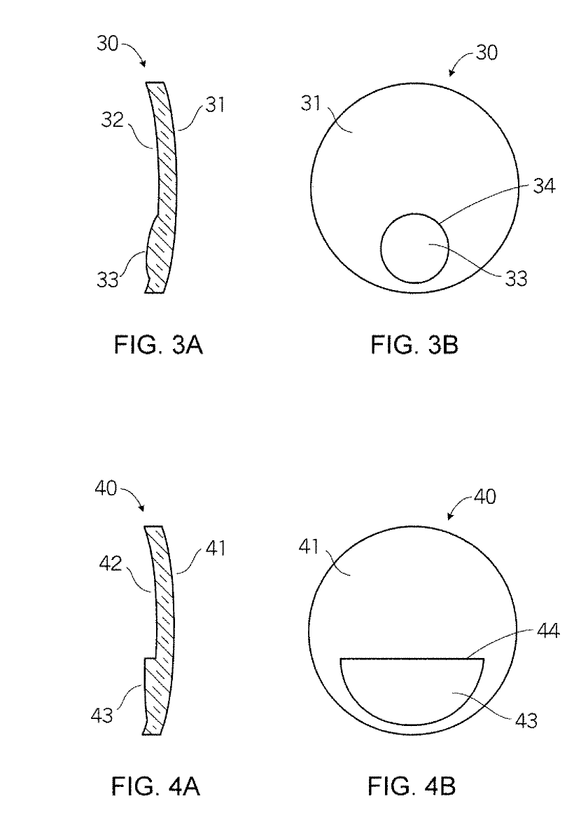

In accordance with an embodiment, referring to FIGS. 3A and 3B, a multifocal lens 30 is comprised of a single piece of material, formed from a single lens blank. The lens 30 includes a convex surface 31 and a concave surface 32. One of the surfaces, preferably the concave surface 32 but optionally the convex surface 31, includes a near segment 33 that has a different radius of curvature than the surface on which it is formed. For example, as shown in the side view of FIG. 3A, the concave surface 32 is concave and faces the wearer's eye. The near segment 33, however, is convex and thus provides near vision correction for the wearer. The size and radius of curvature of near segment 33 can be customized to the needs of the user.

As shown in FIG. 3B, the demarcation between near segment 33 and concave surface (31 in FIG. 3A) may be such that the line of demarcation 34 is visibly perceptible when viewed from the front 31 of the lens 30. Such a line of demarcation yields a lined bifocal (or lined multifocal, in the case of a lens with more than two segments). For the line of demarcation to be visible, in some embodiments the blend zone or area of demarcation between the convex surface 31 and near segment 33 may be less than about 3 millimeters (mm). In other embodiments, the area of demarcation may have a width that is between about 0.1 mm and about 0.5 mm, between about 0.2 mm and about 0.4 mm, between about 0.1 mm and about 0.5 mm, between about 0.1 mm and about 1.0 mm, between about 0.1 mm and about 0.8 mm, or between about 0.3 mm and about 1.0 mm. In some embodiments, the width may vary around the perimeter of the near segment 33.

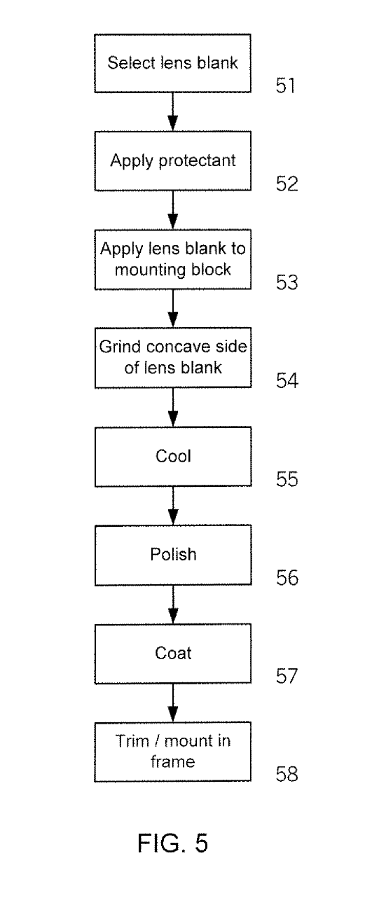

FIG. 3B shows a lens where the near vision segment 33 has a circular or button shape and is surrounded by the distant vision segment 31. Other shapes are possible. For example, referring to FIGS. 4A and 4B, in an alternate embodiment a lens 40 includes a convex surface 41 and a concave surface 42. Here, the near segment 43 is semi-circular in shape and includes a flat top 44 as a portion of its line of demarcation. Other shapes for the near vision segment are possible, and it is possible that the near vision segment may be positioned so that at least a portion of its perimeter comprises an edge of the lens. It is possible that either the near vision segment or the distant vision segments may include one or more sub-segments, or the lens may include multiple near vision segments or distant vision segments to provide a multifocal lens.

In various embodiments, the lenses shown in FIGS. 3A-3B and 4A-4B may be made from a single lens blank of a high-index or mid-index material. The lens blank may be round or any other suitable shape. Referring to FIG. 5, a method of making a lined or blended bifocal lens may include selecting a lens blank 51. The lens blank may be made of a high index material, i.e., a material having a high index of refraction as described above. Alternatively, the lens blank may be made of a mid-index material or other index material. The lens blank may have a base curve, or curvature in the convex side of the lens, that is selected to correspond to the need of the individual wearer. The wearer's eye care specialist may prescribe the base curve. Any lens blank known to those skilled in the art, including pre-made lens blanks, may be used. In an embodiment, the blank may be selected with a diameter that will fit within the frame selected by the wearer. However, blanks may be machined or otherwise trimmed to fit within a frame in alternate embodiments.

The selected blank may then be positioned for layout and blocking. This process may include applying a protectant 52, such as blocking tape, to the convex side of the lens blank (i.e., the side of the lens that will face away from the wearer's eye). Optionally, the protectant may be pre-applied before selection. The protectant may help to shield the convex side of the lens from scratches during the surfacing process. In addition, the protectant may also help to keep working materials from entering into the pores of the lens. Any suitable protectant may be used, such as surface saver tape commonly available from 3M Corporation and Lamart Corporation.

The lens may then be mounted or otherwise affixed to a mounting block 53 using a wax, alloy, pitch, adhesive, or other suitable material such as those that are commercially available and known to those skilled in the art. The block, also known as a chuck receiver or an end block, may be used to hold the lens in place during the surfacing process, and in some embodiments it may be in the shape of a disk or ring that surrounds the edges of the lens or fits within the edges of the lens.

Blocking may be performed by hand or by mechanical methods using a variety of commercially available lens blocking devices, such as machines available from Gerber Coburn and others. Blocking may be done by centering the lens in the block, such that grinding or other surface processing may be performed. Another method of blocking may “decenter” the lens in the block, such that the geometric center of the ring may not correspond to the geometric center of the lens. In either geometric center grinding or decentering, a portion of the lens may be positioned outside of the blocking ring.

Once the lens is blocked, a prism may be ground into the lens based on the needs of the individual patient. The concave or backside of the lens (i.e., the side opposite the applied protectant and which will ultimately face the wearer's eye) may be ground by using a suitable machine or technique 54. Exemplary machines are described in U.S. Pat. No. 6,095,896 to Kobayashi; U.S. Pat. No. 5,890,949 to Shibata; U.S. Pat. No. 5,588,899 to Gottschald; and U.S. Pat. No. 5,549,903 to Nauche et al., each of which is incorporated herein by reference in its entirety. The settings and techniques of the grinding or lathing machine may be set, optionally with commercially available lens machine software, and the settings may use standard or non-standard lens grinding calculations to determine curvature settings for the backside of the lens. Thus, computer numerically controlled (CNC) lens grinding may occur to provide a precise and customized lens for the patient. Preferably, the lens grinding is performed by rotating the lens and contacting the rotating lens with diamond-tipped or other suitable tools to permit precise grinding.

In a typical bifocal grinding or turning method, a geometric one-dimensional surface is formed on the concave or back side of the lens. The surface has a curvature that provides for a patient's problems viewing distant objects. In accordance with the present methods, the backside or concave side of the lens may be ground or processed to provide a three dimensional backside surface including a distant vision segment having a curvature that may provide correction for a patient's problems viewing distant objects, along with one or more near vision segments that may provide correction for a patient's problems viewing near objects. The different radii of curvature may be ground into the concave side of the lens using one or more diamond-tipped or other appropriate cutting tools placed in positions that vary as the lens is turned. The varying positions may relate to factors such as the desired diameter and radius of curvature of the near segment; optical correction variables such as sphere, cylinder and axis; the size of the blend zone between the near vision segment and its adjacent segment (which may be a different near vision segment, or which may be a distant vision segment); and the lens material.

After the lens is ground, the lens may be removed from the machine and allowed to cool 55, preferably for at least about twenty minutes.

The ground lens may then be further finished through polishing 56 the concave side of the lens. The polishing method may include using a soft pouch, such as a silicone-filled pouch having a covering of very mildly abrasive or nonabrasive material, such as a silk pad. A slurry of small micron abrasive material, such as a commercially available plastic lens polish, may be applied to the covered pouch. The covered pouch may conform to the shape of the lens during polishing. Other polishing methods may be used. Optionally, after polishing, the backside of the lens may be coated with a commercially available protective coating 57.

Finally, the lens may be mounted into a frame 58 for use in eyeglasses by the patient. The resulting lens is a unitary (i.e, one-piece) lens, where at least one of the surfaces includes a near vision segment having a first radius of curvature and a distant vision segment having a second radius of curvature that differs from the first radius. Additional near vision or distant vision segments may be present. Preferably, the near vision segment is located on and is integral with the concave surface of the lens—i.e., the surface that is opposite the convex surface and which faces the wearer's eye. The line of demarcation or “blend zone” between at least two of the different segments is visible in that the blend zone has a width that is less than about 3 mm. In some embodiments, the blend zone may have a width that is between about 0.1 mm and about 0.5 mm, between about 0.2 mm and about 0.4 mm, between about 0.1 mm and about 0.5 mm, between about 0.1 mm and about 1.0 mm, between about 0.1 mm and about 0.8 mm, or between about 0.3 mm and about 1.0 mm. In some embodiments, the blend zone width may vary around the perimeter of a near segment.

It will be appreciated that various of the above-disclosed and other features and functions, or alternatives thereof, may be desirably combined into many other different devices or applications. Also, various presently unforeseen or unanticipated alternatives, modifications, variations, or improvements therein may be subsequently made by those skilled in the art.

We claim:

1. A lens comprising:
a first surface and a second surface;
wherein the second surface is positioned opposite the first surface and comprises a near vision segment and a distant vision segment;
wherein an area of demarcation between the near vision segment and the distant vision segment is visible;
wherein the lens is comprised of a single piece of material.

2. The lens of claim 1 wherein the material has a refractory index of about 1.53 or higher.

3. The lens of claim 2 wherein the material has a refractory index that is between about 1.58 and about 1.74.

4. The lens of claim 1 wherein the area of demarcation has a width that is less than about 3 mm.

5. The lens of claim 4 wherein the near vision segment has a perimeter, and the width of the area of demarcation varies around the perimeter.

6. The lens of claim 1 wherein the first surface is convex and the distant vision segment of the second surface is concave.

7. A method of preparing a unitary multifocal lens, comprising:
selecting a lens blank having a first surface that is convex and an opposing second surface; and
grinding the second surface to form a near vision segment and a distant vision segment in the convex surface such that an area of demarcation between the near vision segment and the distant vision segment is visible.

8. The method of claim 7 further comprising polishing the second surface.

9. The method of claim 7 further comprising coating the second surface.

10. The method of claim 7 wherein the grinding comprises turning the lens in the presence of a grinding tool so that the distant vision segment has a concave radius of curvature and the near vision segment has a radius of curvature that is different from that of the distant vision segment.

11. The method of claim 7 wherein the lens blank is a single piece of high-index, polymeric material.

12. A lens comprising:
a convex first surface and a second surface;
wherein the second surface is positioned opposite the first surface and comprises a first near vision segment and a concave distant vision segment;
wherein an area of demarcation between the first near vision segment and the first distant vision segment is visible;
wherein the lens is comprised of a single piece of material having a refractory index of about 1.53 or higher.

13. The lens of claim 12 wherein the material has a refractory index that is between about 1.58 and about 1.74.

14. The lens of claim 12 wherein the area of demarcation has a width that is less than 3 mm.

15. The lens of claim 12 wherein the near vision segment has a perimeter, and the width of the area of demarcation varies around the perimeter.

16. The lens of claim 12, wherein the first near vision segment has a first radius of curvature, and wherein the lens further comprises a second near vision segment having a second radius of curvature.

17. The lens of claim 16, wherein the first near vision segment and the second near vision segment overlap.

18. The lens of claim 12, wherein the first distant vision segment has a first radius of curvature, and wherein the lens further comprises a second distant vision segment having a second radius of curvature.
